(19) United States
(12) Patent Application Publication
(10) Pub. No.: US 2026/0186570 A1
(43) Pub. Date: Jul. 2, 2026

(54) WEARABLE DEVICE

(71) Applicant: Toyota Jidosha Kabushiki Kaisha, Toyota-shi (JP)

(72) Inventor: Tomohiro TSUBOTA, Nagoya-shi (JP)

(73) Assignee: Toyota Jidosha Kabushiki Kaisha, Toyota-shi (JP)

(21) Appl. No.: 19/382,637

(22) Filed: Nov. 7, 2025

(30) Foreign Application Priority Data
Dec. 27, 2024 (JP) 2024-231617

(51) Int. Cl. G06F 3/01

(52) U.S. Cl. CPC G06F 3/014

(57) ABSTRACT

A wearable device includes a base worn on a body, the base made of elastomer; at least one electronic device attached to the base; and at least one conductive thread sewn to the base, the conductive thread electrically connected to the electronic device.

### CROSS REFERENCE TO RELATED APPLICATIONS

This application claims priority to Japanese Patent Application No. 2024-231617, filed Dec. 27, 2024, the disclosure of which is incorporated by reference herein in its entirety.

### BACKGROUND

### Field

The present disclosure relates to a wearable device.

A wearable device to be worn on a body is known (for example, Japanese Patent Application Publication No. 2023-167572).

Conventional wearable devices have a structure in which a sensor, an insulating cable, or the like is incorporated between an inner and an outer, and therefore, there is a problem that the thickness is large and it is difficult to move the body when wearable devices are worn. Therefore, it is desired to make the wearable device thinner.

### SUMMARY

The present disclosure may be realized by the following aspects.

(1) According to the one aspect of the present disclosure, a wearable device is provided. This wearable device comprises a base worn on a body, the base made of elastomer; at least one electronic device attached to the base; and at least one conductive thread sewn to the base, the conductive thread electrically connected to the electronic device.

The wearable device according to this aspect, since the electronic device and the conductive thread are incorporated in one base, it is possible to reduce the thickness of the wearable device.

(2) In the wearable device according to the above aspect, the base may include a base material layer and a coating layer, wherein the base material layer is sewn with the conductive thread, wherein the coating layer covers the conductive thread sewn to the base material layer.

The wearable device according to this aspect, the conductive thread can be protected by the coating layer.

(3) In the wearable device according to the above aspect, the at least one electronic device may include a first electronic device and a second electronic device, wherein the second electronic device is located at a different position from the first electronic device, the conductive thread may have a first portion and a second portion, wherein the first portion is electrically connected to the first electronic device, wherein the second portion is electrically connected to the second electronic device, the first portion and the second portion may be grade separated with an insulator interposed therebetween.

The wearable device according to this aspect, it is possible to increase the degree of freedom in the layout of the conductive thread.

(4) In the wearable device according to the above aspect, the base may be configured in a glove-type, wherein the base is worn on a hand.

The wearable device according to this aspect, it is possible to provide a thinner wearable device that is easy to bend fingers.

### BRIEF DESCRIPTION OF THE DRAWINGS

FIG. 1 is a explanatory view showing the configuration of a wearable device;

FIG. 2 is a cross-sectional view of the wearable device;

FIG. 3 is an explanatory view showing an example of a grade separation portion; and

FIG. 4 is an explanatory view showing another example of the grade separation portion.

### DETAILED DESCRIPTION

### A. Embodiment

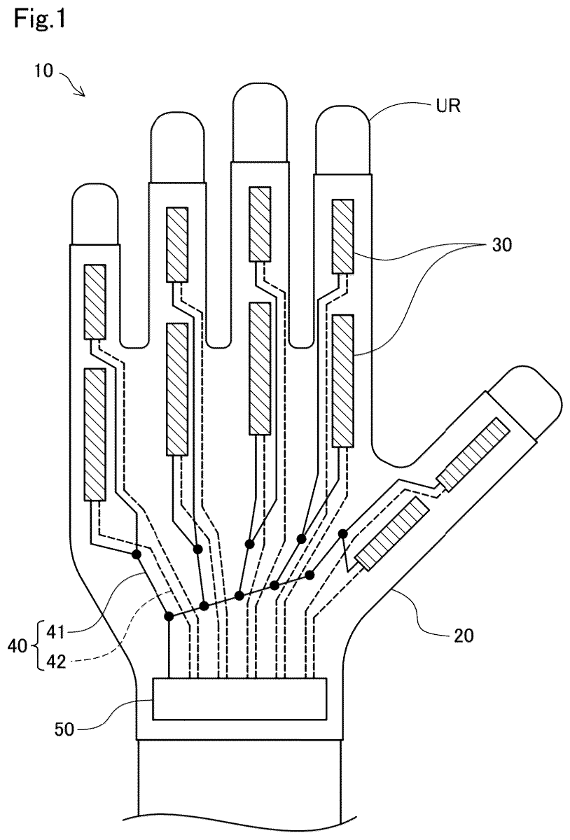

FIG. 1 is an explanatory view showing a configuration of a wearable device 10 as an embodiment of the present disclosure. The wearable device 10 is used while it is worn on a human body. In the present embodiment, the wearable device 10 is worn on a hand of an user UR and is used to detect a bending state of the fingers of the user's UR. The wearable device 10 includes a base 20, a plurality of sensors 30, a plurality of conductive threads 40, and a controller 50. In the present disclosure, the sensor 30 is sometimes referred to as an electronic device.

The base 20 is worn on the hand of the user UR. In the present embodiment, the base 20 is configured in a glove-type manner to cover the part of the user UR from the fingers to the wrist. Base 20 is configured to cover the each finger. The base 20 is configured so that the fingertips are exposed. However, the base 20 may be configured to cover the fingertip. Base 20 is formed of an elastomer having an insulating property. In this embodiment, the base 20 is formed of silicone rubber.

The plurality of sensors 30 are fixed to the base 20. In the present embodiment, the number of sensors 30 is ten. Each sensor 30 is secured to a surface of the base 20 on the back side of the hand. Each sensor 30 is positioned at a position corresponding to a hand-finger joint. Here, each joint of the fingers is referred to as a first joint, a second joint, and a third joint in order from the fingertip. The thumb has a first joint and a second joint, and four fingers other than the thumb have a first joint and a second joint and a third joint. Two of the ten sensors 30 are disposed at a position corresponding to the first joint of the thumb and a position corresponding to the second joint. Eight of the ten sensors 30 are disposed at a position corresponding to the second joint of the four fingers other than the thumb and a position corresponding to the third joint. Each sensor 30 is a bending sensor for detecting the bending state of the fingers. The bending sensor is constructed in the form of a flat plate, and it bends and deforms to follow the operation of the fingers. The bending sensor changes its electrical resistance according to the bending state. Therefore, based on the output voltage of each sensor 30, it is possible to detect the bending state of the fingers. In the present embodiment, each sensor 30 is inserted into a pocket-shaped portion provided in the base 20, and is bonded to the base 20 by silicone rubber.

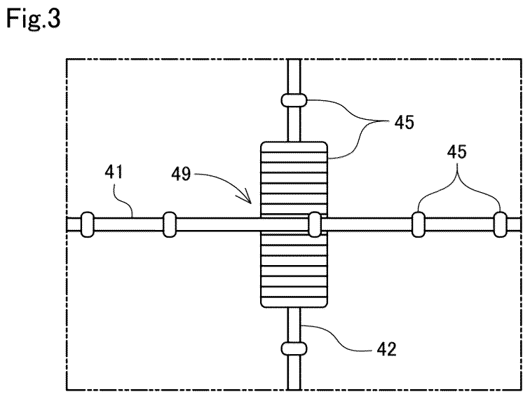

The plurality of conductive threads 40 are sewn to the base 20. The conductive thread 40 is a conductive thread. In the present embodiment, the conductive thread 40 is constituted by a fiber bundle of nylon fibers and a silver plating layer covering the fiber bundle. The conductive thread 40 does not have an insulating coating. In the present embodiment, the conductive thread 40 is sewn to the base 20 in a straight stitch by a lock-stitch sewing machine. The conductive thread 40 is used for the upper thread of the sewing machine, and an insulating thread 45 (see FIG. 3) is used for the lower thread of the sewing machine. The insulating thread 45 is a thread having an insulating property. The insulating thread 45 is constituted by, for example, a fiber bundle of an insulating fiber such as a natural fiber such as cotton, a chemical fiber such as nylon fiber, or a blended fiber containing a natural fiber and a chemical fiber. The insulating thread 45 does not have a metal plating layer or an insulating coating. Incidentally, the conductive thread 40 may be sewn to the base 20 by a chain stitch sewing machine or may be sewn to the base 20 by hand sewing.

The plurality of conductive threads 40 are electrically connected to the sensor 30 and the controller 50 to transmit and receive electrical signals between the sensor 30 and the controller 50. The plurality of conductive threads 40 includes one input-side conductive thread 41 and ten output-side conductive threads 42. In FIG. 1, the input-side conductive thread 41 is represented by a solid line, the output-side conductive thread 42 is represented by a broken line. The input-side conductive thread 41 is branched from one to ten, and has a proximal end portion and ten distal end portions. The proximal end portion of the input-side conductive thread 41 is connected to the controller 50, The distal end portion of the input-side conductive thread 41 is connected to an input-side terminal of the sensor 30. The output-side conductive thread 42 is not branched, and has a single proximal end portion and a single distal end portion. The proximal end portion of the output-side conductive thread 42 is connected to an output terminal of the sensor 30, the distal end portion of the output-side conductive thread 42 is connected to the controller 50.

The controller 50 is secured to a wrist portion of the base 20. In the present embodiment, the controller 50 includes a single terminal to which the proximal end portion of the input-side conductive thread 41 is connected, and ten terminals to which the distal end portion of the output-side conductive thread 42 is connected. The controller 50 comprises a battery that applies a voltage to each sensor 30 via the input-side conductive thread 41 and a circuit board that processes electrical signals acquired from each sensor 30 via the output-side conductive thread 42. The controller 50 may further include a communication device or the like for transmitting the detection result of each sensor 30 to the outside.

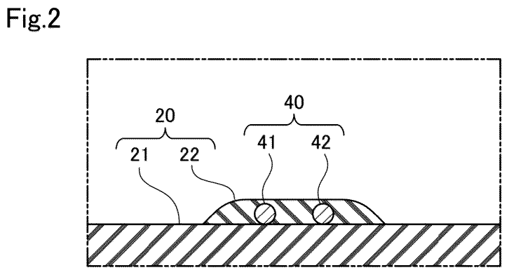

FIG. 2 is a cross-sectional view of the wearable device 10. In this embodiment, the base 20 has a base material layer 21 and a coating layer 22 provided on the base material layer 21. The base material layer 21, the conductive thread 40 is sewn. The coating layer 22 is provided so as to cover the conductive thread 40 sewn to the base material layer 21. The coating layer 22 may be provided on a portion of the base 20 where the conductive thread 40 is disposed, and may not be provided on the entire base 20. In this embodiment, the base material layer 21 and the coating layer 22 are formed of silicone rubber.

Base material layer 21 may be manufactured separately in a plurality of parts. For example, the base material layer 21 may be manufactured separately palm side parts and back side parts. The palm side parts and the back side parts can be manufactured using injection molding machines or 3D printers. The parts on the back side of the hand are preferably in the form of flat plates to facilitate sewing of the conductive thread 40 by a sewing machine. After the conductive thread 40 is sewn to the part on the back side of the hand, the adhesive allowance provided on the part on the palm side of the hand and the part on the back side of the hand is butted and heated, so that both parts are integrated to obtain the base material layer 21 to which the conductive thread 40 is sewn. The excess adhesive charge is preferably cut and removed. The coating layer 22 can be formed by coating the conductive thread 40 sewn to the base material layer 21 with silicone rubber.

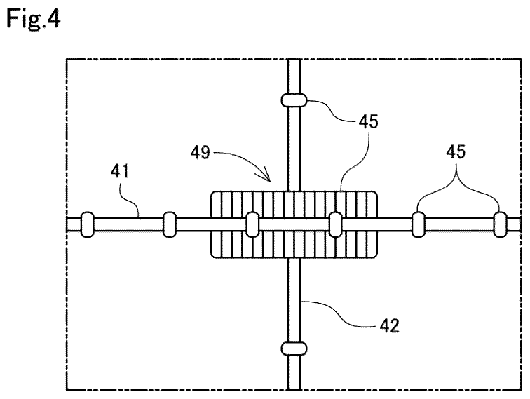

FIG. 3 is an explanatory diagram showing an example of a grade separation portion 49. FIG. 4 is an explanatory diagram showing another example of the grade separation portion 49. As shown in FIG. 3, in the present embodiment, the wearable device 10 has grade separation portion 49 in which two or more conductive threads 40 intersect with an insulator interposed therebetween. In the present embodiment, grade separation portion 49 is constituted by the insulating thread 45 and the input-side conductive thread 41 are arranged on the output-side conductive thread 42. However, the grade separation portion 49 may be constituted by the insulating thread 45 and the output-side conductive thread 42 are arranged on the input-side conductive thread 41. In FIG. 3, the input-side conductive thread 41 and the output-side conductive thread 42 are substantially perpendicular. However, the input-side conductive thread 41 and the output-side conductive thread 42 may intersect at an angle of less than 90 degrees. In the present embodiment, the input-side conductive thread 41 and the output-side conductive thread 42 crossing each other, the sensor 30 of the connection destination are different from each other. However, in the input-side conductive thread 41 and the output-side conductive thread 42 crossing each other, the sensor 30 of the connection destination may be the same.

As shown in FIG. 3, in the present embodiment, the insulating thread 45 is disposed substantially perpendicular to the lower conductive thread 40. However, as shown in FIG. 4, the insulating thread 45 may be disposed substantially parallel to the lower conductive thread 40. In the grade separation portion 49, for example, by satin stitching, the insulating threads 45 are arranged side by side in a high density. It is preferable that the distance between the insulating threads 45 of the grade separation portion 49 be narrower than the diameter of one of the upper conductive threads 40 and the lower conductive threads 40 whose angle with respect to the insulating thread 45 is small. In the present embodiment, the spacing of the insulating threads 45 of the grade separation portion 49 is approximately zero and is narrower than the diameter of the input-side conductive thread 41 which is the upper conductive thread 40 and narrower than the diameter of the output-side conductive thread 42 which is the lower conductive thread 40. In the present disclosure, one of the two conductive threads 40 constituting the grade separation portion 49 is sometimes referred to as a first portion, the other is sometimes referred to as a second portion. The first portion and the second portion may be two portions branched from one input-side conductive thread 41. When the first portion and the second portion are connected to different sensors 30, the sensor 30 to which the first portion is connected is sometimes referred to as a first electronic device, and the sensor 30 to which the second portion is connected is sometimes referred to as a second electronic device.

According to the wearable device 10 in the present embodiment described above, the sensor 30 and the conductive thread 40 are incorporated in one base 20. Therefore, the base portion is constituted by two layers of the inner and outer, as compared with the form in which the sensor and the insulating cable is incorporated between the inner and outer, the configuration of the wearable device 10 can be simplified, and the wearable device 10 can be made thinner. In particular, in the present embodiment, in order to transmit and receive an electrical signal of the sensor 30, since the conductive thread 40 having no insulating coating is used, as compared with the form in which the insulating cable having an insulating coating is used, the wearable device 10 can be effectively thinned. Further, in the present embodiment, the conductive thread 40 is sewn to the base 20, so that the base 20 and the conductive thread 40 are integrated. Therefore, the configuration of the wearable device 10 can be effectively simplified.

In addition, when the wearable device 10 is a globe type that is worn on the hand, if the thickness is increased, it becomes difficult to bend fingers, and thus the feeling of wearing and workability become poor. In contrast, in the present embodiment, since the wearable device 10 is made thinner, it is possible to provide the wearable device 10 having a good wearing feeling and workability.

Further, in the present embodiment, the conductive thread 40 sewn to the base material layer 21 of the base 20 is covered by the coating layer 22. Therefore, it is possible to protect the conductive thread 40 from external force or the like by the coating layer 22.

In addition, in this embodiment, the base material layer 21 and the coating layer 22 of the base 20 are formed of silicone rubber. Therefore, it is possible to increase the waterproof and rust resistance of the portion where the conductive thread 40 is sewn. In addition, in the present embodiment, since the waterproofing of the portion where the conductive thread 40 is sewn is enhanced, it is possible to clean the wearable device 10 with water.

Further, in the present embodiment, the input-side conductive thread 41 is branched from one to ten. Therefore, it is possible to reduce the number of input-side conductive thread 41. Incidentally, when the input-side conductive thread 41 is not branched, one of the input-side conductive thread 41 is required for one sensor 30.

Further, in the present embodiment, the input-side conductive thread 41 and the output-side conductive thread 42 is provided with the grade separation portion 49 which crosses each other with an insulating thread 45. Therefore, it is possible to increase the layout freedom of the conductive thread 40.

### B. Other Embodiments

(B1) The wearable device 10 according to the above-described embodiment includes the sensor 30 that detects the bending state of the finger. In contrast, the wearable device 10 may be provided with an acceleration sensor for detecting the hand acceleration, a gyro sensor for detecting an angular velocity of the hand, a pressure sensor for detecting a pressure applied to the hand, or the like, instead of the sensor 30 for detecting the bending state of the fingers. The wearable device 10 may include, in addition to the sensor 30 for detecting the bending state of the hand, for example, the acceleration sensor for detecting acceleration of the hand, the gyro sensor for detecting the angular velocity of the hand, the pressure sensor for detecting the pressure applied to the hand, and the like. The wearable device 10 may include an electronic device such as a LED, a speaker, and an actuator in place of the sensor 30. The wearable device 10 may include an electronic device such as the LED, the speaker, and the actuator in addition to the sensor 30.

(B2) In the wearable device 10 of the above-described embodiment, the base 20 is configured to be a globe type that is worn on the hand. In contrast, the base 20, for example, may be configured in an armband type to be worn on the arm, may be configured in a sock type to be worn on the foot, it may be configured in a headband type to be worn on the head.

(B3) The wearable device 10 of the above embodiment includes a plurality of sensors 30 and a plurality of conductive threads 40. In contrast, the number of sensors 30 provided in the wearable device 10 may be one, or the number of conductive threads 40 provided in the wearable device 10 may be one.

(B4) The wearable device 10 of the above embodiment includes the coating layer 22 overlying a conductive thread 40. In contrast, the wearable device 10 may not include the coating layer 22.

(B5) Wearable device 10 of the above-described embodiment has the grade separation portion 49 in which two or more conductive threads 40 intersect each other with an insulator interposed therebetween. In contrast, the wearable device 10 may not include the grade separation portion 49.

(B6) The wearable device 10 of the above-described embodiment includes the controller 50. In contrast, the wearable device 10 may be configured separately from the controller 50.

(B7) In the wearable device 10 according to the above-described embodiment, the device is used while being worn on the human body. In contrast, the wearable device 10 may be used while being worn on the human body of a human robot.

The disclosure is not limited to any of the embodiment and its modifications described above but may be implemented by a diversity of configurations without departing from the scope of the disclosure. For example, the technical features of any of the above embodiments and their modifications may be replaced or combined appropriately, in order to solve part or all of the problems described above or in order to achieve part or all of the advantageous effects described above. Any of the technical features may be omitted appropriately unless the technical feature is described as essential in the description hereof.

What is claimed is:

1. A wearable device, comprising:
a base worn on a body, the base made of elastomer;
at least one electronic device attached to the base; and
at least one conductive thread sewn to the base, the conductive thread electrically connected to the electronic device.

2. The wearable device according to claim 1,
wherein the base includes a base material layer and a coating layer, wherein the base material layer is sewn with the conductive thread, wherein the coating layer covers the conductive thread sewn to the base material layer.

3. The wearable device according to claim 1,
wherein the at least one electronic device includes a first electronic device and a second electronic device, wherein the second electronic device is located at a different position from the first electronic device,
wherein the conductive thread has a first portion and a second portion, wherein the first portion is electrically connected to the first electronic device, wherein the second portion is electrically connected to the second electronic device,
wherein the first portion and the second portion are grade separated with an insulator interposed therebetween.

4. The wearable device according to claim 1,
wherein the base is configured in a glove-type, wherein the base is worn on a hand.
